(19) United States
(12) Patent Application Publication
(10) Pub. No.: US 2025/0121308 A1
(43) Pub. Date: Apr. 17, 2025

(54) IN-LINE AIR SEPARATOR AND FLUID DECELERATION METHOD AND APPARATUS

(71) Applicant: Downhole Chemical Solutions, LLC, Frisco, TX (US)

(72) Inventors: Zach West, Youngsville, LA (US); Jacob Deshotels, Lafayette, LA (US)

(73) Assignee: Downhole Chemical Solutions, LLC, Frisco, TX (US)

(21) Appl. No.: 18/914,994

(22) Filed: Oct. 14, 2024

Related U.S. Application Data
(60) Provisional application No. 63/544,089, filed on Oct. 13, 2023.

(51) Int. Cl. B01D 45/08; B01D 45/06

(52) U.S. Cl. CPC B01D 45/08; B01D 45/06

(57) ABSTRACT

A gas-liquid separator is described, for use in sequence with an eductor or other mechanism for mixing dry chemicals into a carrier fluid such as water, where such mechanisms often entrain air into the fluid. The separator comprises an inlet port directing fluid towards a turbulent zone (created by an internal baffle with at least one gap at the bottom). The gas and liquid are separated in the turbulent zone, and collected by outlets positioned above and below the gap in the baffle, respectively.

### REFERENCE TO RELATED APPLICATIONS

This is a utility patent application claiming priority to U.S. Provisional Application Ser. No. 63/544,089, filed 13 Oct. 2023, by the same inventors and also titled “In-Line Air Separator and Fluid Deceleration Method and Apparatus.” The contents of the above-referenced provisional application are incorporated in full.

### FIELD OF THE INVENTION

The present invention generally relates to an improved system, method, and apparatus for separating water and air, and, more particularly, to an apparatus for separating water from the air from the fluid effluent of a jet-type fluid eductor or injector.

### BACKGROUND OF THE INVENTION

Conventional powder hydration of frac polymers and dry additives is achieved by using a jet-type eductor or injector, often called a jet pump or venturi pump, which is a device that uses fluid flow to create a vacuum that draws in and mixes another substance without moving parts, in this case, a powder.

An eductor-mixer system is effective for batch or continuously mixing a powder and a liquid to form a dispersion, slurry, or solution. A basic description of the conventional eductor operation when combining water with dry polymer or other dry powder involves using a motive fluid formed by pumping water under pressure into the eductor. This water is the “motive fluid” pressurized to flow through a converging nozzle inside the eductor. As the water flows through the nozzle, it accelerates, and its pressure decreases. The motive fluid exits the nozzle and enters the eductor's venturi or throat section. The accelerated water flow in the venturi section creates a vacuum due to the principle of the Venturi effect. The vacuum created by the venturi effect pulls the powder into the eductor, typically through a suction port at the venturi or throat section. Inside the throat of the eductor, the powder is intensely mixed with the water using the turbulence and velocity of the motive fluid. This thorough mixing ensures that powder gets well dispersed or dissolved in water-powder hydration. After the throat, the mixture of water and powder enters the eductor's diverging section or diffuser. Here, the fluid pressure decreases. This decrease in pressure allows for additional mixing of the powder into the water. The mixed or hydrated solution of water and dissolved or dispersed powder is discharged from the eductor into a connected conduit for transporting the fluid to a downstream vessel. In a simple description, an eductor uses the flow and pressure of water traveling through a constriction to form a vacuum to draw in and mix a powder, making it an efficient and straightforward device for combining water and dry powder materials.

A low to high-pressure air stream may aid in dispersing and conveying dry powder via a conduit over a distance into the eductor body. This air enters the water, increasing the air concentration in the eductor's effluent fluid stream.

Conventional eductors do not separate water from the entrained air in the downstream conduit, resulting in air-entrained water exiting the eductor and downstream conduit with increased hydraulic force.

Examples of prior art patents utilizing eductor or mechanical mixing processes include U.S. Pat. Nos. 4,860,959; 5,989,318; 6,190,461; and 10,737,226.

A characteristic aspect of the eductor is how the water pressure increases and accelerates by constricting water flow as the water enters the eductor's body. The constriction creates a Venturi effect by increasing the flow velocity of the water, creating more significant hydraulic turbulence and mixing action within the eductor. The vacuum from the eductor pulls in air, entraining the air within the water stream. The entrained air-in-water stream significantly increases the stream's total volumetric flow, resulting in a significant velocity increase through the same cross-sectional area, creating difficulty in handling.

As the water-powder mixture or solution travels downstream in the conduit, it carries energy from the flow of the motive fluid through the eductor. The mixture of air and water continues to mix in the downstream conduit until discharged in a downstream vessel. The entrained air travels with the water powder mixture to the discharge outlet. The resultant solid slurry or powder solution discharges from the conduit, connected to the outlet of the eductor. At the point of fluid discharge, the entrained and non-entrained air creates a forceful discharge of water and air as it exits the conduit downstream of the eductor.

Accordingly, with prior art eductor systems (e.g., U.S. Pat. No. 10,737,226), it is inadvisable to directly discharge the fluid downhole, into a mixing tank, due to the entrained gas and the resulting force of the air-liquid mixture. In these cases, a separate fluid holding tank, or atmospheric tank, is needed to receive the discharged water, dissipating the kinetic energy of the fluid and allowing it to settle and release the entrained gas. The top of the tank is covered to prevent unwanted splashing of the fluid discharges into the tank, but is otherwise open to the atmosphere. The degassed fluids are then pumped out from the holding tank via suction line and transfer pump to move the fluid to the frac pump suction and mixing tank. (For purposes of this disclosure, the term “eductor” encompasses both devices referred to as “eductor” and “ejector” in the '226 patent).

The need for a holding tank capable of dispersing the momentum and releasing the entrained gas in large quantities of fluid can add considerable expense and weight to a fluid mixing operation, which is especially a consideration in mobile units.

One alternative would be a two-phase separator, industrial equipment designed to separate liquid and a gas. Separators operate by leveraging the differences in densities and gravitational forces between the two phases, allowing for the efficient separation of the liquid (water) from the gas (air). Typical applications include wastewater treatment plants and pipeline remediation. Separators can be installed horizontally or vertically depending on the flow of the mixture.

In horizontal separators, the mixture flows horizontally. The liquid phase, being denser, settles at the bottom due to gravity, while the gas phase rises to the top. The mixture flows vertically in vertical separators, with the gas phase moving upwards and the liquid phase moving downwards. Horizontal separators typically require more ground space but are shorter in height, making them suitable for locations with space constraints in height. Vertical separators, on the other hand, have a smaller footprint but are taller. Vertical separators are generally more efficient for gas-liquid separation when the liquid volume is low, as the gas can rise and the liquid can fall simultaneously. Horizontal separators might be more efficient when there's a higher volume of liquid, as they provide a larger settling area. Horizontal separators can be easier to maintain and clean due to their orientation, especially when solids are in the mixture. Vertical separators might require more effort in cleaning the bottom sections.

An in-line, unified system is needed to provide air separation from the flow of the water, air, and powder solution, along with decelerating the fluid flow before discharge-thereby removing the need for a secondary pump or fluid release tank to contain fluids and release the air and pressure force of the fluid, instead permitting discharge directly into the pump suction mixer tank. There is a further need for such a system to combine the elements of vertical and horizontal separation in a single, compact embodiment to reduce the space costs of horizontal separation and the maintenance requirements of vertical separation.

Embodiments of the invention, as described herein, meet this need.

### SUMMARY OF THE INVENTION

This invention relates to an in-line two-phase separator located downstream of a powder-fluid eductor to serve as a method to remove entrained air and decelerate fluid flow at the point of downstream discharge. The in-line air separator apparatus also eliminates the need for a separate fluid discharge tank positioned downstream of the eductor. Unlike a traditional horizontal or vertical separator, which is a standalone vessel, this invention teaches the use of an inline separator to be an integrated part of the conduit downstream of the eductor. It typically has a cylindrical shape larger than the conduit's diameter, ensuring a smooth flow.

As the mixed phase fluid exits the eductor and enters the conduit and then the inline separator, changes in velocity and pressure caused by the internal design of the separator encourage air separation. Just as in a traditional separator, gravity plays a key role. The entrained air bubbles rise due to their lower density, while the water flow remains within the conduit.

The inline separator contains one or more internal baffles or other structures to promote the coalescence of the air droplets or to change the flow dynamics, allowing for better separation. As the air accumulates in the top part of the separator, it is vented off or redirected to the desired location through an air or gas outlet.

The separated liquid, being denser, remains at the bottom or continues to flow along the conduit's path. It is discharged or allowed to flow downstream through the liquid conduit to an outlet. The efficiency of the inline separator is based on the design, the flow rates, and the specific conditions of the process. The advantage of the separator is that it allows for a more minor space requirement for the eductor by removing the need for an additional tank and transfer pump.

The unique invention combines several techniques and apparatuses to make it possible to facilitate discharging water or liquid fluid from an eductor without less pressure to avoid disruptive splashing or the need for a downstream water-holding tank. The invention makes it much easier for operators to release fluids mixed with eductors directly into a pump suction or mixing tank.

The removal of air offers several advantages over the conventional eductor discharge method by decreasing the size or footprint of a unit, reducing the overall power required to operate, eliminating the need for a pump to convey the fluid to a vessel or other process, reducing failure rates by incorporating fewer moving parts, and increases the redundancy by the overall simplicity of the design.

In an embodiment, the present invention is installed at an angle, so that the flow is not purely vertical or purely horizontal.

The current invention may be equipped with continuous process measurement sensors connected to an electronic control system capable of sending a signal to an onboard and remote computing system to document the process and offer remote control.

### BRIEF DESCRIPTION OF DRAWINGS

In the detailed description of embodiments usable within the scope of the disclosure, presented below, reference is made to the accompanying drawings:

FIG. 1 depicts a generalized eductor process flow of a method with the depiction of the water powder mix zone and air entrainment zone.

FIG. 2 depicts an embodiment of the cross-section of an inline air separator according to the present invention.

FIGS. 3A-3F depict a three-dimensional schematic of the inline air separator according to the present invention.

FIG. 4 shows the inline air separator in context with an eductor on a frame.

### DETAILED DESCRIPTION OF THE DRAWINGS

Before describing selected embodiments of the present disclosure in detail, it is to be understood that the present invention is not limited to the embodiments described herein. The disclosure and description herein illustrate and explain one or more presently preferred embodiments and variations thereof. It will be appreciated by those skilled in the art that various changes in the design, organization, order of operation, means of operation, equipment structures and location, methodology, and use of mechanical equivalents may be made without departing from the spirit of the invention.

Also, it should be understood the drawings are intended to illustrate and disclose presently preferred embodiments to one of skill in the art but are not intended to be manufacturing-level drawings or renditions of final products and may include simplified conceptual views as desired for easier and quicker understanding or explanation. Also, the relative size and arrangement of the components may differ from that shown and still operate within the spirit of the invention.

Moreover, it will be understood that various directions such as “upper,” “lower,” “bottom,” “top,” “left,” “right,” and so forth are made only with respect to explanation in conjunction with the drawings and that the components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

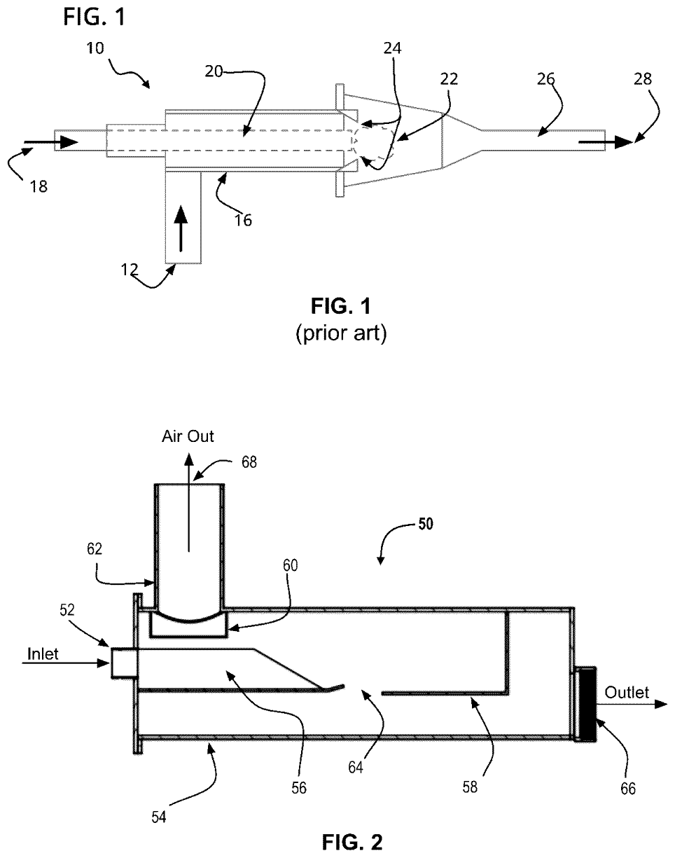

Turning first to FIG. 1, a generalized eductor process flow diagram 10 operates by combining water and dry powder in mixing and air entrainment zones. In the figure, a fluid inlet conduit 12 conveys a motive fluid (in an embodiment, water) into eductor body 16. A stream of powder enters via a powder inlet conduit 18, conveying dry powder along with a stream of air into the eductor body 16. The stream of water and dry powder engage with each other in a mixing zone 22 created by a short constriction 24 at the end of fluid path 20, causing fluid to accelerate and increase pressure as it exits the fluid path 20 through construction 24. The fluid flow across the opening of the fluid path 20 results in the Venturi effect creating a low-pressure zone to aid in sucking the powder and delivering air into the mixing zone 22. The mixed fluid and powder travels downstream from the eductor via conduit 26 to discharge outlet 28.

Turning now to FIG. 2, a cross-sectional depiction of an embodiment of the air separator 50 is depicted. In the embodiment, this separator 50 is located downstream of the eductor 10. Entrained fluid enters the air separator via inlet 52 into the body of the air separator housing 54. The fluid travels via an inlet guide 56 with an elevated lip 57 at the terminus, which directs the fluid flow across and upward, where it impinges upon the internal baffle 58. The resulting turbulence redirects the fluid back to the mid-section of the air separator, turning it into a turbulent impact zone. The resulting deceleration of the fluid stream allows the gas and liquid to separate. The liquid sinks down through the opening 64 between the inlet guide and the baffle 58 and flows toward outlet 66 into a downstream conduit. The gas flows upward into the opening 60 at the base of the air exhaust pipe 62, and up to the outlet 68 where it releases into the local atmosphere. The estimated removal efficiency for air removal is between 50 and 90% of the amount of air entering the separator from the amount of air exiting the separator. As a result of the air removal, the fluid is discharged into the downstream process with lower flow intensity. The reduced flow intensity achieved allows for the mixed fluid to be used directly without needing a downstream discharge tank and transfer pump to moderate the flow later in the process.

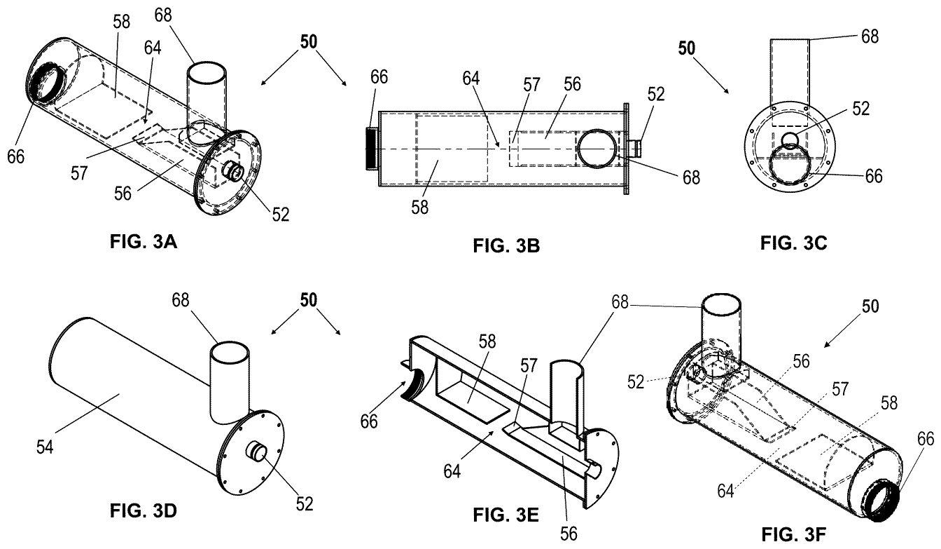

Turning now to FIGS. 3A-3F (numbered identically to FIG. 2), a transparent perspective view of the embodiment depicted in cross-section in FIG. 2 is shown in FIG. 3A, with corresponding top views and front views in FIGS. 3B and 3C, respectively. Among other details, it can be appreciated that the fluid inlet guide 56 comprises two side channel walls which slope down towards the lip 57. The liquid outlet 66 is offset low from the longitudinal axis of the separator body 54, and degassed fluid flows underneath baffle 58 once it exits the upper opening 64. External views, in FIGS. 3D and 3F, show the separator body facing in both directions. Cutaway view in FIG. 3E shows the longitudinal symmetry of the embodiment.

Prior advancements in water and air separation have attempted to remove the air in a closed pipe environment, preserving a high amount of hydraulic energy capable of conveying water a great distance. The present invention introduces a novel approach, distinct from the prior art, that addresses the challenge of separating air from a water stream downstream from a fluid eductor and offers advantages in terms of efficiency, reliability, and cost-effectiveness. While the water and air separator of the present invention incorporates some of the functional elements commonly found in numerous other water and air separators, what sets it apart is its distinctive use and positioning of the elements, such as baffles and air outlet placement.

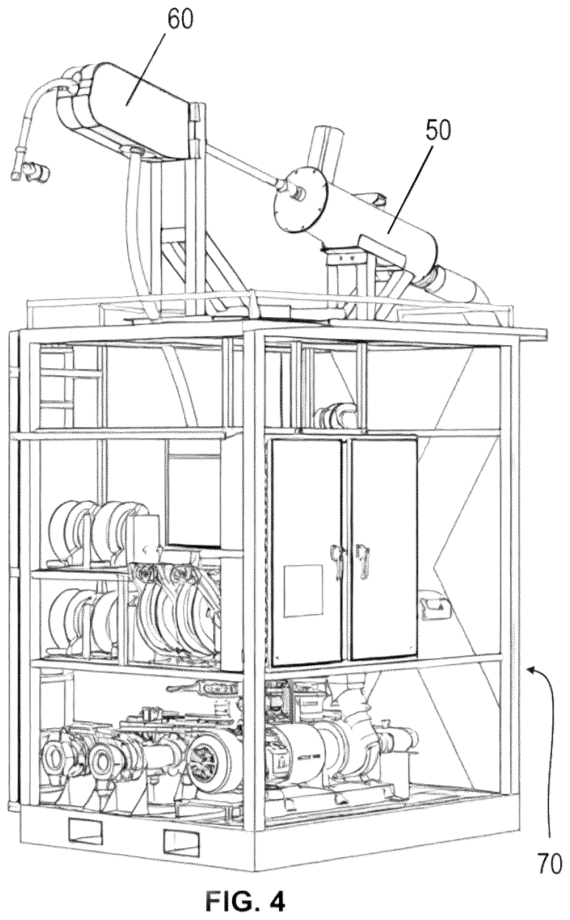

Additionally, utilizing a water and air separator downstream of a water eductor is a novel application in industry. Turning now to FIG. 4, the separator 50 is shown in context with the eductor 60 on a treatment frame 70. The separator 50 is positioned at an angle (in the depicted embodiment, roughly −15°) and downstream from the eductor, such that the separator acts both horizontally and vertically. This unique arrangement and integration with the water eductor offers a unique approach to separation processes and enhancing the overall efficiency and effectiveness of the system.

While various embodiments usable within the scope of the present disclosure have been described with emphasis, it should be understood that within the scope of the appended claims, the present invention can be practiced other than as specifically described herein.

1. A gas-liquid separator comprising:
an inlet terminating in a lip directing mixed fluid to a baffle;
a gas outlet located above the inlet;
a gap between the lip and the baffle; and
a liquid outlet located beneath the baffle,
wherein the separator receives mixed fluid from an eductor via the inlet, wherein the lip causes mixed fluid to impact the baffle, causing separation of the gas and the liquid, wherein the gas rises to the gas outlet, and wherein the liquid sinks to the liquid outlet.

2. The gas-liquid separator of claim 1, further comprising a housing enclosing the baffle and the space through which fluid flows from the inlet, and to the gas outlet and liquid outlet.

3. The gas-liquid separator of claim 2, wherein the lip comprises a terminal surface angled up towards the top of the housing, and wherein the angled surface elevates the direction of the fluid flow past the gap and into the baffle.

4. The gas-liquid separator of claim 2, further comprising an inlet guide extending into the housing from the inlet, the inlet guide comprising at least one internal vertical side forming an inlet channel to narrow the possible flow path of fluid as it approaches the lip.

5. The gas-liquid separator of claim 2, wherein the gas outlet is located at a distance from the housing and fluidly connected thereto by an exhaust pipe leading from the gas outlet to an opening in the separator housing.

6. The gas-liquid separator of claim 1, wherein the liquid outlet is located beneath a longitudinal center axis of the separator housing.

7. A method of separating gas and liquid in a fluid comprising:
directing a mixed fluid having both gas and liquid entrained through an inlet into a separator housing;
creating an impact zone where the mixed fluid turbulently impacts an internal baffle within the separator housing;
positioning an internal gas outlet rearward and above the impact zone, and an internal liquid outlet forward and below the impact zone; and
positioning the separator housing such that the gas bubbles rise towards the internal gas outlet, and the degassed liquid sinks towards the internal liquid outlet.

8. The method of claim 7, wherein the step of creating an impact zone involves directing the fluid from the inlet, via at least one inlet guide, towards an elevated lip leading across an internal gap in the baffle.

9. The method of claim 7, wherein the step of positioning the separator housing comprises tilting the separator housing such that it is at a non-zero angle perpendicular to the angle of the inlet fluid flow.

10. The method of claim 7, wherein the step of positioning an internal gas outlet rearward and above the impact zone comprises positioning the internal gas outlet external to the separator housing, connected thereto by a conduit.

11. The method of claim 7, wherein the step of positioning an internal liquid outlet forward and below the impact zone comprises positioning the internal liquid outlet beneath a longitudinal axis of the inlet.

12. The method of claim 7, further comprising the step of directly conveying the degassed liquid from the internal liquid outlet into a subterranean wellbore or casing.
